(19) United States
(12) Patent Application Publication
(10) Pub. No.: US 2019/0021516 A1
(43) Pub. Date: Jan. 24, 2019

(54) BABY CHANGING APPARATUS AND METHOD OF USE

(71) Applicant: Rebecca Joyner, Fort Worth, TX (US)

(72) Inventor: Rebecca Joyner, Fort Worth, TX (US)

(21) Appl. No.: 16/041,319

(22) Filed: Jul. 20, 2018

Related U.S. Application Data
(60) Provisional application No. 62/534,863, filed on Jul. 20, 2017.

(51) Int. Cl. A47D 5/00; B60N 3/00

(52) U.S. Cl. CPC A47D 5/003; B60N 3/004

(57) ABSTRACT

A baby changing apparatus includes a mat having an appropriate size to hold a child in a lying down position; a back attached to the mat and having a strap to secure the baby changing apparatus to a vehicle seat; and a securing device to secure the mat in a folded position against the back; the mat is to unfold from the back to provide a surface on which to place the child.

### BACKGROUND

### 1. Field of the Invention

The present invention relates generally to baby changing systems, and more specifically, to a baby changing apparatus for use in a stationary automobile.

### 2. Description of Related Art

Baby changing systems are well known in the art and are effective means to hold an infant while they are being dressed or changed. For example, a common practice involves plastic tables located in public restrooms which allow parents to change their children while traveling.

One of the problems commonly associated with conventional baby changing systems is sanitation. For example, many parents use the tables located in restrooms and therefore the tables can become dirty and unsanitary. In addition, tables are not located in all public restrooms, thereby forcing parents to improvise and change or dress their children in alternate locations.

Accordingly, although great strides have been made in the area of baby changing systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are oblique views of a baby changing apparatus in accordance with a preferred embodiment of the present application;

FIG. 2 is a back view of the baby changing apparatus of FIG. 1 in a closed position;

FIG. 3 is a side view of the baby changing apparatus of FIG. 1;

FIG. 4 is a partial side view of the mat of FIG. 1; and

FIG. 5 is a flowchart of the method of use of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional baby changing systems. Specifically, the present invention provides a means to change a baby in a vehicle, thereby eliminating the need for using a public restroom changing table. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

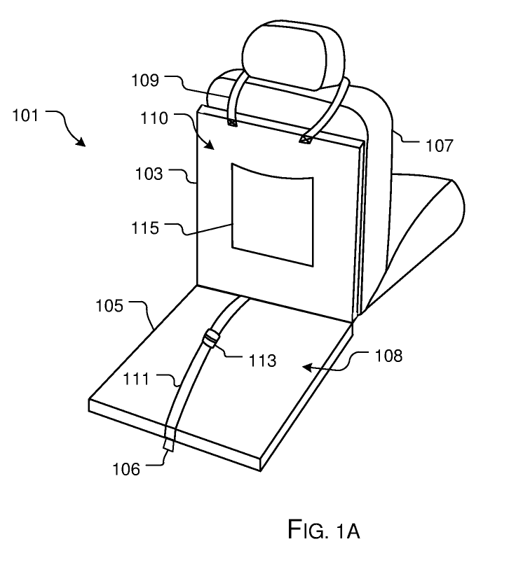

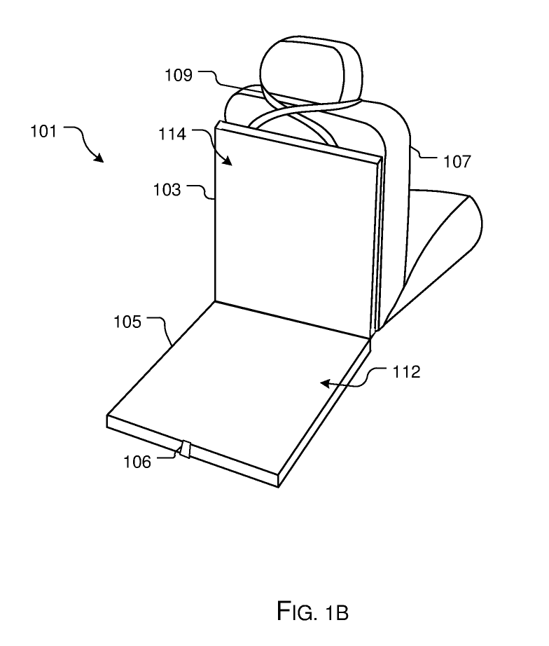

Referring now to the drawings wherein like reference characters identify corresponding or similar elements throughout the several views, FIGS. 1A and 1B depict oblique views of a baby changing apparatus 101 in accordance with a preferred embodiment of the present application. It will be appreciated that apparatus 101 overcomes one or more of the above-listed problems commonly associated with conventional baby changing systems.

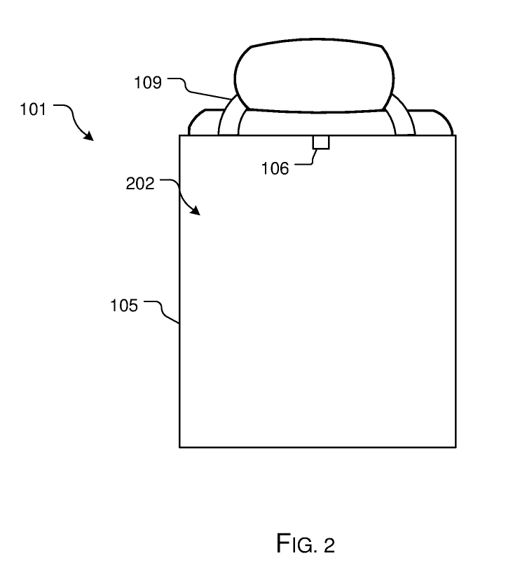

In the contemplated embodiment, apparatus 101 includes a back 103 attached to a mat 105 and secured to a vehicle seat 107 via one or more straps 109. It should be appreciated that straps 109 can be adjustable and alternative means of securing apparatus 101 to seat 107 could be employed. Mat 105 is configured to fold down, thereby providing a substantially flat surface 108 on which to place a child. It should be appreciated that mat 105 can fold onto a lap of a parent sitting in the back seat (not shown). When in a closed position (as shown in FIG. 2), mat 105 is secured in place via a securing device 106 such as a hook and loop fastener, a button, a snap or a similar means.

In the preferred embodiment mat 105 is substantially rectangular and sized appropriately to receive a child thereon. Mat 105 can be composed of various materials, including nylon, cotton, or plastic. In the preferred embodiment, mat 105 includes a strap 111 with an adjustment means 113 configured to secure over a child for safety. Apparatus 101 can further include one or more pockets 115 on an interior surface 110 of back 103 for securing wipes, cloths, clothes, or other items.

As shown in FIG. 1B, apparatus 101 is configured to flip over and open, thereby providing a hard surface 112 to be used as a desk by a parent or child sitting in the back seat. For example, a person can place a notepad or writing pad on surface 112 for writing and or drawing. It should be understood that surface 114 in this position, is the surface that rests against the back of seat 107 in FIG. 1A.

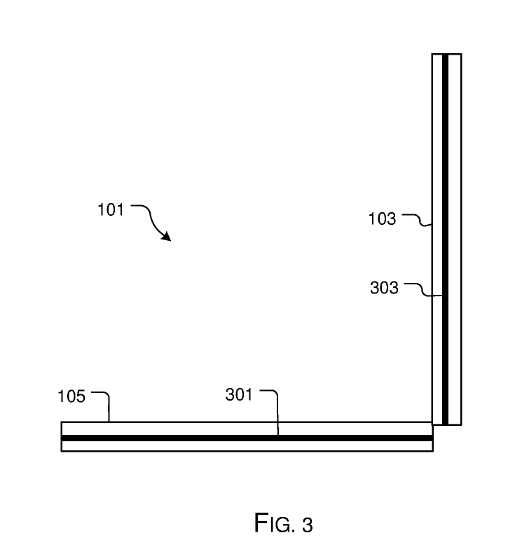

In FIG. 3, a simplified profile view of apparatus 101 is shown. It should be appreciated that mat 105 and back 103 can include zippers 301, 303 thereby providing access to an interior of the back and mat. It should be appreciated that zippers 301, 303 provide a means to remove padding, foam, plastic, or any other components from the interiors of back 103 and mat 105 for washing and sanitation.

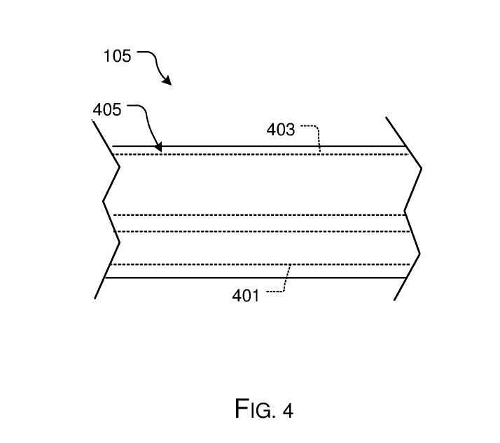

In FIG. 4, a partial side view demonstrates one configuration of mat 105, wherein a hard component 401 and a pad 403 are secured within the interior 405 of mat 105. It should be understood that back 103 can have similar components. It should further be appreciated that the interior can include just one of either the pad or the hard component. The hard component (if included) provides structure to mat 105 while the pad 403 can provide a comfortable cushion to support the infant when in use.

It should be appreciated that one of the unique features believed characteristic of the present application is the configuration allowing for the apparatus to be conveniently secured in a vehicle. It should be understood that this feature provides a means for a parent to change a child in their vehicle and forgo the use of a public restroom.

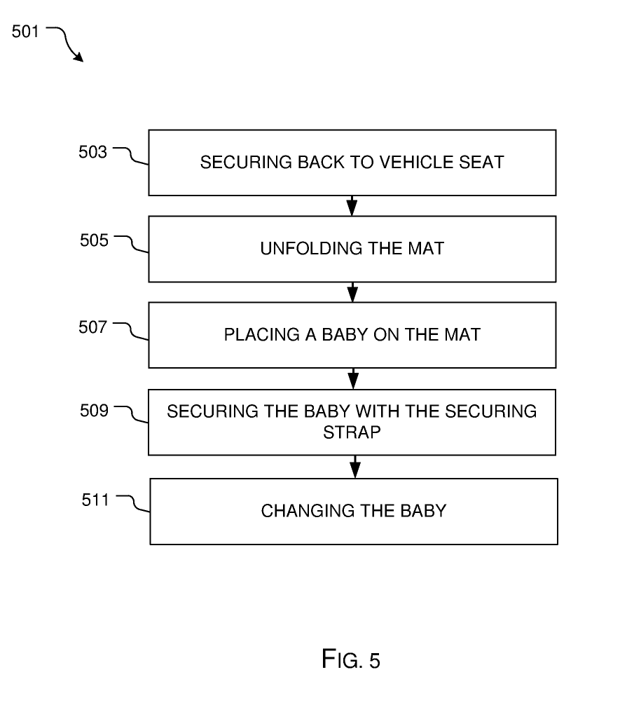

In FIG. 5, a flowchart 501 depicts a method of use of apparatus 101. During use, the apparatus is secured to a vehicle seat, as shown with box 503. As needed, the mat is released from the back and unfolded, thereby providing a surface on which to place an infant for changing, as shown with boxes 505, 507. The infant is placed on the mat and secured in place (if necessary), and the parent proceeds to change the infant, as shown with boxes 509, 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A baby changing apparatus, comprising:
a mat having an appropriate size to hold a child in a lying down position;
a back attached to the mat and having a strap configured to secure the baby changing apparatus to a vehicle seat; and
a securing device configured to secure the mat in a folded position against the back;
wherein the mat is configured to unfold from the back to provide a surface on which to place the child.

2. The apparatus of claim 1, further comprising:
a securing strap attached to an interior surface of the mat and configured to hold the child on the mat.

3. The apparatus of claim 1, further comprising:
a pocket secured to an interior surface of the back.

4. The apparatus of claim 1, further comprising:
a pad positioned within an interior area of the mat.

5. The apparatus of claim 1, wherein the mat has a hard backing secured within an interior area of the mat.

6. The apparatus of claim 1, wherein the back has a hard backing configured to rest against the vehicle seat.

7. The apparatus of claim 1, wherein the mat further comprises:
a zipper configured to open into an interior of the mat.

8. A method of changing a baby, the method comprising:
providing the baby changing apparatus of claim 1;
opening the baby changing apparatus by detaching the securing device to allow the mat to fold into an open position;
placing the baby on a top surface of the mat and securing the baby in place by one or more straps; and
changing the baby.

9. The method of claim 8, further comprising:
removing a pad from an interior of the mat.
